(19) United States
(12) Patent Application Publication
(10) Pub. No.: US 2026/0086297 A1
(43) Pub. Date: Mar. 26, 2026

(54) OPTICAL CONNECTOR PLUG AND LOCK TOOL

(71) Applicant: SEIKOH GIKEN Co., Ltd., Matsudo-shi (JP)

(72) Inventor: Junji TAIRA, Matsudo-shi (JP)

(21) Appl. No.: 19/408,349

(22) Filed: Dec. 4, 2025

Related U.S. Application Data
(63) Continuation of application No. PCT/JP2025/009276, filed on Mar. 12, 2025.

(30) Foreign Application Priority Data
Mar. 26, 2024 (JP) 2024-049128

(51) Int. Cl. G02B 6/38

(52) U.S. Cl. CPC G02B 6/3893; G02B 6/3825

(57) ABSTRACT

An optical connector plug fitted to an optical adapter including: a latch engageable with the optical adapter by moving a tip end in a vertical direction; and a lock arm movable relative to the latch, wherein the lock arm includes a lock portion movable between a first position overlapping a bottom surface of the latch and a second position not overlapping the bottom surface of the latch in a plan view, the lock portion is arranged at the second position not overlapping the bottom surface of the latch in the plan view when the optical connector plug is not fitted to the optical adapter, and the lock arm is pressed by an inner wall of the optical adapter so that the lock portion moves to the first position overlapping the bottom surface of the latch in the plan view when the optical connector plug is fitted to the optical adapter.

### CROSS-REFERENCE TO RELATED APPLICATIONS

This Application claims the benefit of priority and is a Continuation application of the prior International Patent Application No. PCT/JP2025/009276, with an international filing date of Mar. 12, 2025, which designated the United States, and is related to the Japanese Patent Application No. 2024-049128, filed Mar. 26, 2024, the entire disclosures of all applications are expressly incorporated by reference in their entirety herein.

### TECHNICAL FIELD

The present invention relates to an optical connector plug and a lock tool for locking the optical connector plug.

### BACKGROUND OF THE INVENTION

An optical fiber cable is connected to an optical module such as a receiver and a transmitter or to another optical fiber cable via an optical adapter (including a so-called receptacle). Therefore, an optical connector plug to be fitted to the optical adapter is provided at a terminal portion of the optical fiber cable. In a device such as a communication device in which optical modules are mounted or a distribution panel that relays optical fiber cables, multiple optical adapters may be densely arranged from the viewpoint of miniaturization of the device. Various structures have been developed for optical connector plugs to facilitate attachment and detachment operations to optical adapters.

The optical connector plug described in Patent Document 1 is provided with a slider configured to be slidable around the outer periphery of the optical connector plug, and it is possible to release the engagement of the latch with the optical adapter by displacing latches engageable with the optical adapter by the slider. Furthermore, the optical connector plug is provided with a structure that prevents the engagement of the optical connector plug with the optical adapter from being unintentionally released when the slider is touched by mounting a stopper to the optical connector plug.

### PRIOR ART DOCUMENT

### Patent Documents

Patent Document 1: Japanese Patent Publication No. 2021-81717

### SUMMARY OF THE INVENTION

### Problem to be Solved by the Invention

In the optical connector plug described in Patent Document 1, the downward movement of the slider is restricted by the stopper to prevent the engagement of the optical connector plug with the optical adapter from being unintentionally released. However, the optical connector plug of Patent Document 1 does not have a structure that directly restricts the downward movement of the latches. Therefore, when a strong force is applied to the optical fiber cable, such as when a foot is caught on the optical fiber cable, the engagement of the optical connector plug with the optical adapter may be released.

The present invention provides an optical connector plug and a lock tool capable of preventing the engagement of the optical connector plug with the optical adapter from being unintentionally released by directly restricting the downward movement of the latches.

Means for Solving the Problems

An optical connector plug according to one embodiment of the present invention is an optical connector plug fitted to an optical adapter, the optical connector plug including: a plug body that accommodates an optical fiber in the plug body; a latch configured to be engageable with the optical adapter by moving a tip end of the latch in a vertical direction; and a lock arm configured to be movable relative to the latch, wherein the lock arm includes a lock portion configured to be movable between a first position overlapping a bottom surface of the latch in a plan view and a second position not overlapping the bottom surface of the latch in the plan view, when the optical connector plug is not fitted to the optical adapter, the lock portion is arranged at the second position not overlapping the bottom surface of the latch in the plan view, and when the optical connector plug is fitted to the optical adapter, the lock arm is pressed by an inner wall of the optical adapter so that the lock portion moves to the first position overlapping the bottom surface of the latch in the plan view. In the optical connector plug configured as described above, when the optical connector plug is fitted to the optical adapter, the lock portion moves to the first position overlapping the bottom surface of the latch. Thus, downward movement of the latch is restricted.

In the above described configuration, it is also possible to further include a slider configured to be slidable relative to the plug body, wherein when the slider is slid, the latch is configured to move toward an outer surface of the plug body. In the optical connector plug configured as described above, the lock portion is moved to the first position overlapping the bottom surface of the latch. Thus, downward movement of the latch due to operation of the slider is also restricted.

In the above described configuration, it is also possible to configure such that when the optical connector plug is fitted to the optical adapter, the lock portion is positioned between the bottom surface of the latch and an outer surface of the plug body to restrict a movement of the latch toward the outer surface of the plug body. In the optical connector plug configured as described above, downward movement of the latch is restricted by the lock portion when the lock portion is positioned between the bottom surface of the latch and the outer surface of the plug body.

In the above described configuration, it is also possible to configure the lock arm to slide in conjunction with the slider. In the optical connector plug configured as described above, the lock arm is slid relative to the plug body by sliding the slider.

In the above described configuration, it is also possible to configure such that when the optical connector plug is removed from the optical adapter, the lock arm is configured to move in a direction away from the optical adapter so that the lock portion moves to the second position not overlapping the bottom surface of the latch in the plan view. In the optical connector plug configured as described above, the restriction of downward movement of the latch by the lock portion is released by moving the lock arm in a direction away from the optical adapter.

In the above described configuration, it is also possible to configure such that when the optical connector plug is fitted to the optical adapter, the lock arm is pressed by the inner wall of the optical adapter and elastically deformed so that the lock portion moves to the first position overlapping the bottom surface of the latch in the plan view. In the optical connector plug configured as described above, the position of the lock portion relative to the latch is changed by elastic deformation of the lock arm.

In the above described configuration, it is also possible to configure such that the inner wall of the optical adapter is a side wall of the optical adapter, and when the optical connector plug is fitted to the optical adapter, the lock arm is pressed horizontally by the side wall of the optical adapter so that the lock portion moves to the first position overlapping the bottom surface of the latch in the plan view. In the optical connector plug configured as described above, the position of the lock arm relative to the latch is changed by the lock arm when the lock arm is pressed against the side wall of the optical adapter and moved horizontally.

In the above described configuration, it is also possible to configure such that the lock portion is formed on a tip end side of the lock arm, and the lock arm includes a portion protruding toward the inner wall of the optical adapter from a straight line connecting a tip end of the lock portion and a base end of the lock arm in the plan view. In the optical connector plug configured as described above, the position of the lock portion relative to the latch is changed by the lock arm when the lock portion is pressed against the inner wall of the optical adapter at the portion protruding toward the inner wall of the optical adapter.

In the above described configuration, it is also possible to configure the lock arm to have a positioning portion protruding upward on both sides in a width direction of the latch. In the optical connector plug configured as described above, the lock portion is more reliably moved to the first position overlapping the bottom surface of the latch by positioning the latch in the width direction by the positioning portion.

In the above described configuration, it is also possible to configure such that the optical connector plug is a dual-core plug accommodating two optical fibers, each of the two optical fibers corresponding to the optical fiber, the latch and the lock arm are provided for each of the two of the optical fibers, and two lock arms are arranged at positions sandwiching two latches in the plan view, each of the two lock arms corresponding to the lock arm, each of the two latches corresponding to the latch. In the optical connector plug configured as described above, lock portions provided on the two lock arms respectively move to positions overlapping the bottom surfaces of the two latches. Thus, downward movement of the two latches is restricted.

The present invention can also be realized as a lock tool mounted on an optical connector plug fitted to an optical adapter.

### Effects of the Invention

According to the present invention, it is possible to provide an optical connector plug and a lock tool capable of preventing the engagement of the optical connector plug with the optical adapter from being unintentionally released by directly restricting the downward movement of the latch.

### BRIEF DESCRIPTION OF DRAWINGS

FIG. 1 is a perspective view showing an entire optical connector plug.

FIG. 2 is a perspective view of an optical adapter.

FIG. 3 is a front view of the optical adapter.

FIG. 4 is a perspective view of the optical connector plug in a state where a lock tool is removed.

FIG. 5 is a perspective view of the optical connector plug in a state where the lock tool is removed.

FIG. 6 is a perspective view of the lock tool.

FIG. 7 is a plan view of the lock tool.

FIG. 8 is a side view of the lock tool.

FIG. 9 is a front view of the lock tool.

FIG. 10 is a view showing a state where the optical adapter and the optical connector plug are separated.

FIG. 11 is a view showing a state where a tip end of the optical connector plug is inserted into the optical adapter.

FIG. 12 is a view showing a state where the optical connector plug is further inserted into the optical adapter.

FIG. 13 is a view showing a state where the optical connector plug is fitted to the optical adapter.

### DETAILED DESCRIPTION OF THE INVENTION

Hereinafter, embodiments of the present invention will be explained with reference to the drawings shown as examples. In the embodiments described below, a dual-core optical connector plug incorporating two optical fibers will be described as an example.

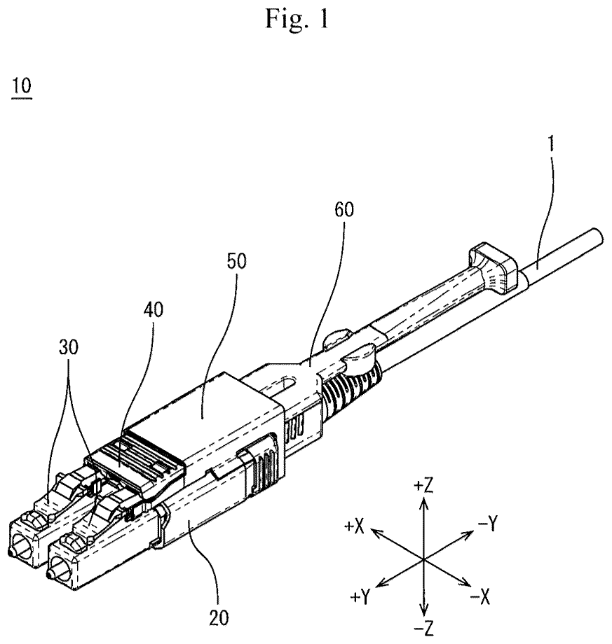

FIG. 1 is a perspective view showing an entire optical connector plug 10. As shown in FIG. 1, the optical connector plug 10 is attached to a terminal portion of an optical fiber cable 1. The optical connector plug 10 is composed of a plug body 20, two latches 30, a slider 40, a lock tool 50 and a jig 60. In the following explanation, the direction in which the two latches 30 are arranged is defined as a left-right direction, a leftward direction is defined as +X direction and a rightward direction is defined as −X direction. In addition, the longitudinal direction of the optical connector plug 10 is defined as a front-rear direction, a mounting direction for mounting the optical connector plug 10 to the optical adapter 2 is defined as a +Y direction and a removal direction for removing the optical connector plug 10 from the optical adapter 2 is defined as a −Y direction. Furthermore, a height direction of the optical connector plug 10 is defined as an up-down direction, an upward direction is defined as a +Z direction and a downward direction is defined as a −Z direction. The plug body 20 is a portion which accommodates the optical fiber cable 1 inside the plug body 20 and is inserted into the optical adapter 2. The latches 30 extend toward the mounting direction (+Y direction) of the plug body 20 and have a structure engageable with the optical adapter 2. The slider 40 is supported by the plug body 20 and has a structure slidable in the front-rear direction (+Y direction, −Y direction) relative to the plug body 20. The lock tool 50 is configured to be attachable to and detachable from the slider 40. The jig 60 is configured to be insertable into the slider 40 from the removal direction (−Y direction) side. When the optical connector plug 10 attached to the optical fiber cable 1 is fitted to the optical adapter 2, the optical fiber cable 1 is connected to an optical module or another optical fiber cable via the optical connector plug 10 and the optical adapter 2. Details of the structure of each part of the optical connector plug 10 will be described later.

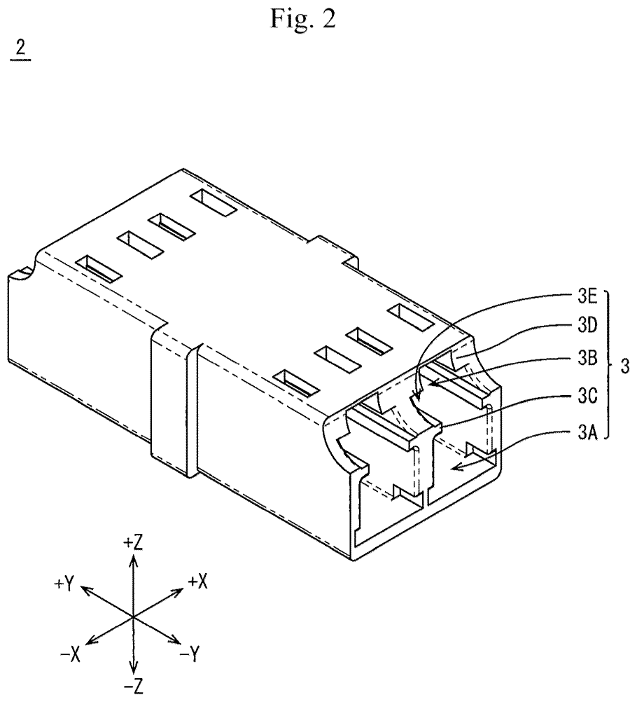

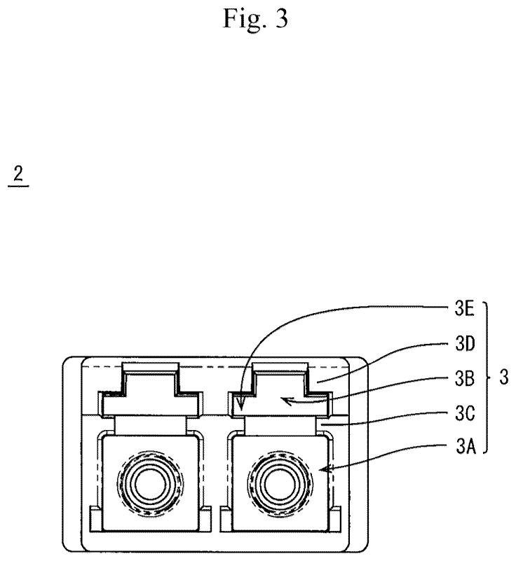

FIG. 2 is a perspective view of the optical adapter 2. FIG. 3 is a front view of the optical adapter 2. Each direction in FIG. 2 corresponds to each direction explained in FIG. 1. The optical adapter 2 has two fitting holes 3 into which the plug body 20 and the latches 30 of the optical connector plug 10 can be inserted. Since the two fitting holes 3 have the same structure, only one fitting hole 3 will be explained in the following explanation. The fitting hole 3 is composed of a plug accommodation hole 3A located on the lower (−Z direction) side for accommodating the plug body 20 and a latch accommodation hole 3B located on the upper (+Z direction) side for accommodating the latch 30. The plug accommodation hole 3A and the latch accommodation hole 3B are continuous near the center in the left-right direction. However, the plug accommodation hole 3A and the latch accommodation hole 3B are separated in the up-down direction by protrusions 3C protruding inward from the side walls on both left and right sides. The plug accommodation hole 3A has a rectangular shape in cross-section that is slightly larger than the outer shape of the plug frame 21 located at the tip end of the plug body 20. The lower portion of the latch accommodation hole 3B forms a wide portion 3E having a rectangular shape in cross-section with a width slightly larger than the width of an engaging portion 31 of the latch 30. The upper portion of the latch accommodation hole 3B has an opening width smaller than the wide portion 3E of the lower portion of the latch accommodation hole 3B since protrusions 3D are protruded inward from the side walls on both left and right sides. Namely, the opening of the latch accommodation hole 3B has an inverted T-shape. The protrusions 3D are formed from the end portion on the removal direction (−Y direction) side of the latch accommodation hole 3B toward the mounting direction (+Y direction) side for a predetermined length in the front-rear direction. Since the protrusions 3D are not formed in the region deeper (on the +Y direction side) than the predetermined length, the latch accommodation hole 3B has a substantially rectangular shape with the same width for both the upper and lower portions in that region.

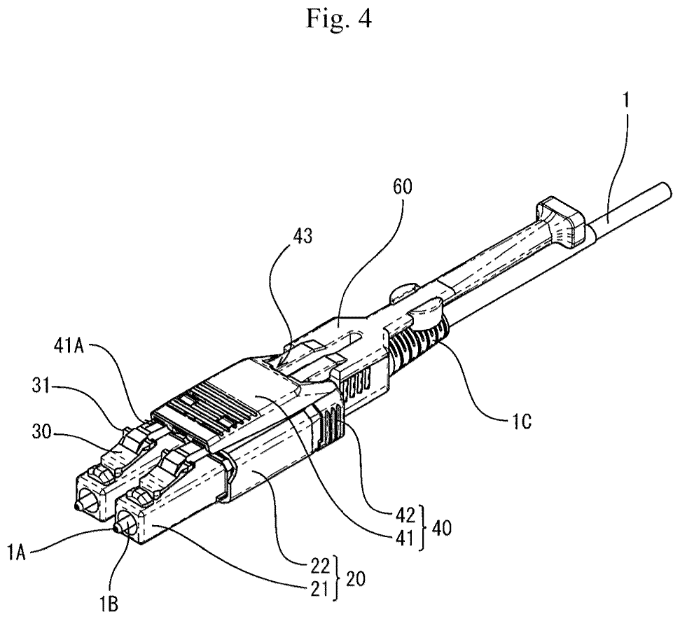

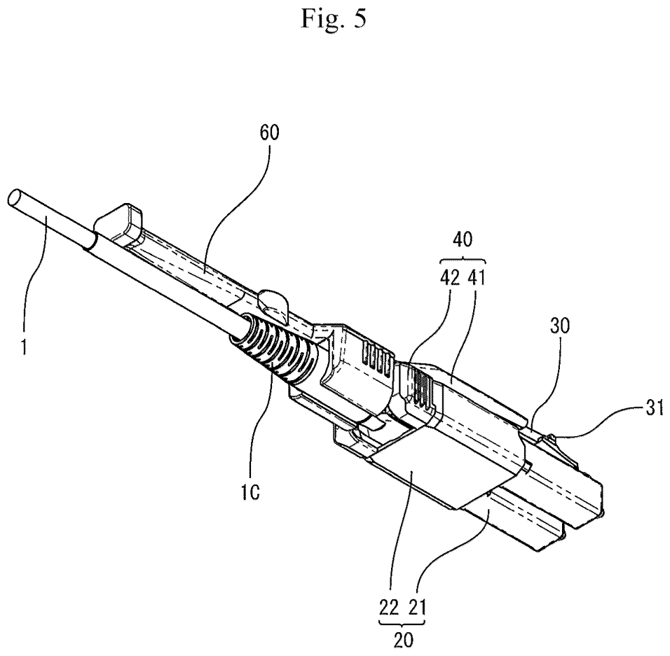

FIG. 4 and FIG. 5 are perspective views of the optical connector plug 10 in a state where the lock tool 50 is removed. FIG. 4 is a view viewed from above while FIG. 5 is a view viewed from below. The plug body 20 is composed of two plug frames 21 formed in a cylindrical shape and a latch frame 22 that supports the latches 30. A ferrule 1B holding an optical fiber 1A inside the optical fiber cable 1 is inserted through the plug frame 21 and the latch frame 22 and protrudes from the end portion of the plug frame 21 in the mounting direction. A boot 1C is inserted through the optical fiber cable 1 drawn from the end portion of the latch frame 22 in the removal direction to cover the periphery of the optical fiber cable 1 for preventing damage to the optical fiber cable 1 due to bending of the cable.

The plug frame 21 is provided for each ferrule 1B and is formed in a cylindrical shape to cover the ferrule 1B from the outside. The inner wall of the plug frame 21 has a circular cavity when viewed from the mounting direction The ferrule 1B holding the optical fiber 1A is arranged at the center of the inner wall of the plug frame 21. The outer wall of the plug frame 21 is formed in a substantially rectangular shape conforming to the shape of the inner wall of the plug accommodation hole 3A of the optical adapter 2 when viewed from the mounting direction.

The latch frame 22 is formed in a substantially rectangular cylindrical shape to cover the portion where the two plug frames 21 are connected on the removal direction (−Y direction) side from the outside. The latch frame 22 is configured to be attachable to and detachable from the plug frame 21 by sliding in the front-rear direction relative to the plug frame 21. Two latches 30 are supported on the upper surface (outer surface) of the latch frame 22. The latches 30 are arranged to extend from the upper surface of the latch frame 22 toward the mounting direction (+Y direction). When the latch frame 22 is mounted to the plug frame 21, the tip end portions of the latches 30 abut against (contact with) the upper surface of the plug frame 21. The base end portions of the latches 30 are fixed to the outer surface of the latch frame 22. While the tip end portions of the latches 30 abut against the upper surface of the plug frame 21, a gap is formed between the latches 30 and the plug frame 21 in the intermediate portion other than the base end portion and the tip end portion. When the latches 30 are pressed from above, the latches 30 are elastically deformed with the base end portion and the tip end portion as fulcrums. Because of this, the distance between the latches 30 and the plug frame 21 is displaced in the intermediate portion of the latches 30. Namely, the latches 30 move in the up-down direction. The engaging portion 31 having engaging protrusions protruding toward both sides in the left-right direction is formed in the intermediate portion of each of the latches 30. When a downward force is applied to the latches 30 to deform the latches 30 closer to the outer surface of the plug frame 21, the distance between the plug frame 21 and the latches 30 is changed to enable movement of the engaging portion 31 in the up-down direction. When the engaging portion 31 moves downward, contact between the protrusion 3D provided on the optical adapter 2 and the engaging portion 31 is avoided. Thus, insertion or removal of the optical connector plug 10 to or from the optical adapter 2 is enabled. When the elastic deformation of the latches 30 is released in a state where the optical connector plug 10 is inserted into the optical adapter 2, the engaging portion 31 is engaged by the protrusion 3D. Thus, the optical connector plug 10 can be fixed in a state inserted into the optical adapter 2.

The slider 40 is composed of a cover portion 41 arranged on the upper surface of the latch frame 22 and a grip portion 42 arranged on the removal direction (−Y direction) side of the latch frame 22. The outer surface (upper surface) of the latch frame 22 and the inner surface (lower surface) of the cover portion 41 of the slider 40 face each other in a state where the latches 30 are sandwiched between them. When the cover portion 41 is displaced downward toward the outer surface of the latch frame 22, the cover portion 41 presses the latches 30. Thus, the latches 30 are elastically deformed toward the outer surface of the latch frame 22. Because of this, the latches 30 are pressed downward and elastically deformed. Thus, the latches 30 are moved toward the outer surface of the latch frame 22.

Two sliding grooves 41A for accommodating the two latches 30 are formed on the inner surface (lower surface) of the cover portion 41. The sliding grooves 41A extend in the sliding direction of the slider 40. Since the latches 30 are accommodated in the sliding groove 41A, the slider 40 is configured to be movable in the mounting direction and the removal direction relative to the outer surface of the plug body 20. When a force is applied to the slider 40 in the removal direction, the slider 40 slides in the removal direction relative to the plug body 20 and the inclined surface inside the sliding groove 41A presses the latches 30 toward the outer surface of the plug frame 21. Because of this, the latches 30 can be elastically deformed. Namely, when the slider 40 is slid in the removal direction, a force similar to pressing the cover portion 41 toward the outer surface of the plug frame 21 can be applied to the latches 30. When the force applied to the slider 40 in the removal direction is released, the elastic deformation of the latches 30 is released and the slider 40 is configured to slide toward the insertion direction. Note that the structure for pressing the latches 30 toward the outer surface of the plug frame 21 by sliding the slider 40 is a known structure. Therefore, detailed explanation is omitted.

The grip portion 42 is a portion gripped by an operator when sliding the slider 40. The grip portion 42 is formed integrally with the cover portion 41 and is arranged at the end portion of the plug body 20 in the removal direction. The grip portion 42 slides around the outer periphery of the plug body 20 in the mounting direction and the removal direction in conjunction with the cover portion 41. An insertion hole having an arc-shaped is formed on the grip portion 42 for inserting the boot 1C in the insertion hole at the end portion of the grip portion 42 in the removal direction. In addition, an insertion hole 43 having a rectangular shape is formed on the cover portion 41 for inserting the jig 60 in the insertion hole 43 at the end portion of the cover portion 41 in the removal direction.

The jig 60 is configured to be insertable toward the mounting direction (+Y direction) from the insertion hole 43 provided in the cover portion 41 of the slider 40. The tip end of the jig 60 branches into two in the left-right direction. When the side surfaces of the jig 60 are pressed inward, the left-right distance of the tip end of the jig 60 can be reduced. Protrusions protruding toward the left side (+X direction) and the right side (−X direction) are formed at the tip end of the jig 60. An inclination is formed on the tip end of the protrusion so that the width of gradually increases from the mounting direction toward the removal direction in a plan view. When the tip end of the jig 60 is inserted into the insertion hole 43, the inclined portion at the tip end of the jig 60 is pressed by the inner wall of the insertion hole 43 and elastically deformed inward. Thus, the protrusions are engaged inside the insertion hole 43. When removing the jig 60, the jig 60 is pulled out in the removal direction while pressing the side surfaces of the jig 60 inward. Since the structure of the jig 60 is a known structure, detailed explanation is omitted.

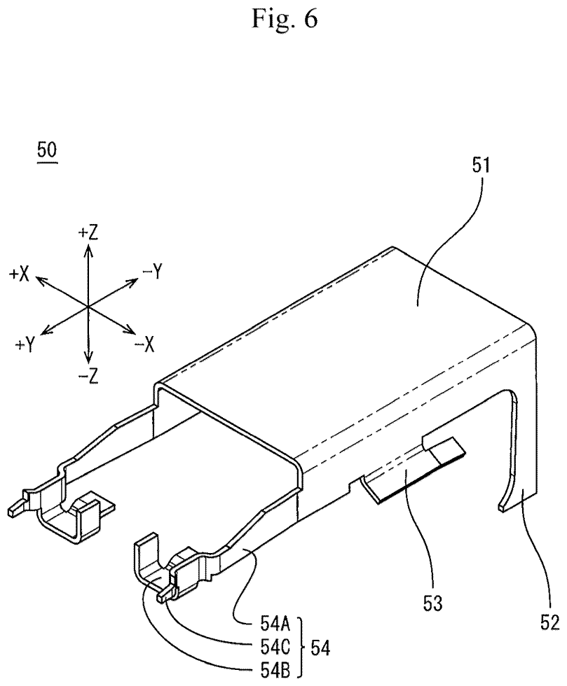

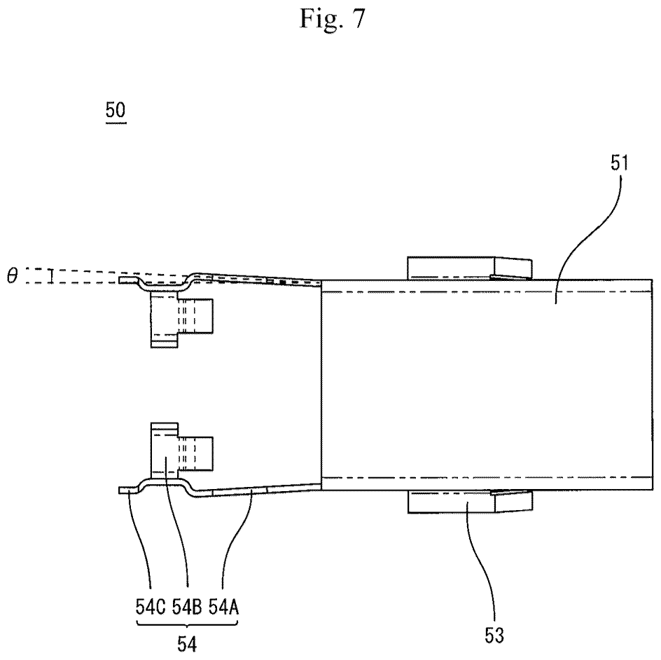

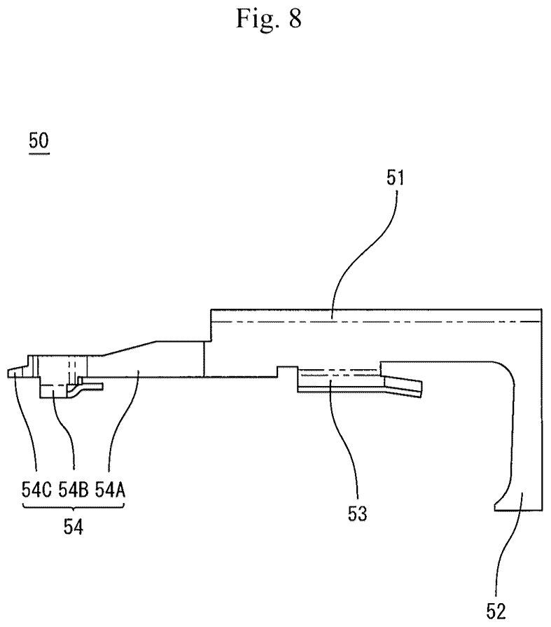

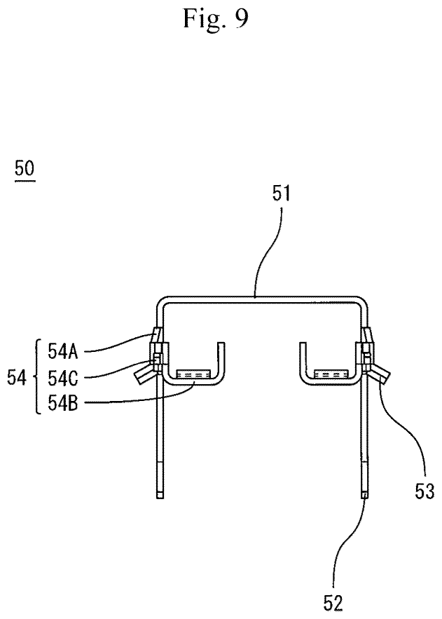

FIG. 6 is a perspective view of the lock tool 50. FIG. 7 is a plan view of the lock tool 50. FIG. 8 is a side view of the lock tool 50. FIG. 9 is a front view of the lock tool 50. Each direction in FIG. 6 corresponds to each direction explained in FIG. 1. The lock tool 50 is formed of a thin plate of stainless steel and is configured to be attachable to and detachable from the slider 40. To mount the lock tool 50 to the slider 40, the lock tool 50 is inserted into the latch frame 22 from the mounting direction side toward the removal direction side in a state where the latch frame 22 is removed from the plug frame 21. When the lock tool 50 is mounted to the latch frame 22, the lock tool 50 is configured to be slidable in the mounting direction and the removal direction in conjunction with the slider 40. Namely, the lock tool 50 is configured to be movable in the mounting direction and the removal direction relative to the latches 30. The lock tool 50 includes: a body portion 51 arranged to cover the upper surface and side surfaces of the slider 40; two leg portions 52 extending downward at the end portion of the body portion 51 in the removal direction; wide portions 53 extending outward from both left and right side walls of the body portion 51; and two lock arms 54 extending toward the mounting direction from the end portion of the body portion 51 in the mounting direction. The body portion 51 is formed in an inverted U-shape in a front view by a top plate arranged on the upper surface of the slider 40 and two side walls extending downward from both left and right sides of the top plate. The leg portions 52 extend downward with a predetermined width in the front-rear direction. The lower end portion of the leg portions 52 is formed to expand in a predetermined width toward the mounting direction (+Y direction). It can also be said that a protrusion extending toward the mounting direction (+Y direction) is formed at the lower end of the leg portions 52. When the lock tool 50 is mounted to the slider 40, as shown in FIG. 1, the end portion of the lower end portion of the leg portion 52 in the mounting direction (+Y direction) abuts against the end portion of the grip portion 42 of the slider 40 in the removal direction (−Y direction). The wide portions 53 are connected to the body portion 51 on the mounting direction (+Y direction) side. A gap is formed between the wide portion 53 and the body portion 51 on the removal direction (−Y direction) side. When the lock tool 50 is mounted to the slider 40, as shown in FIG. 1, the end portion of the wide portion 53 in the removal direction (−Y direction) abuts against the end portion of the grip portion 42 of the slider 40 in the mounting direction (+Y direction).

The lock arm 54 includes: an arm body 54A formed continuously with the body portion 51; a positioning portion 54B arranged on the mounting direction side of the arm body 54A at a position covering the outside of the latches from below; and a lock portion 54C located at the end portion of the lock arm 54 in the mounting direction. The arm body 54A is formed in a plate shape by extending the side wall of the body portion 51 toward the insertion direction. The arm body 54A has a predetermined height in the up-down direction. The height of the arm body 54A is formed uniformly on the side close to the body portion 51 while the height is formed to gradually decrease toward the tip end side. The positioning portion 54B is formed in a U-shape in a front view by a bottom plate arranged below the latches 30 and two side walls extending upward from both left and right sides of the bottom plate. One of the two side walls of the positioning portion 54B is formed continuously with the arm body 54A. The lock portion 54C is formed in a plate shape continuously with the arm body 54A and the positioning portion 54B. The height of the lock portion 54C is lower compared to the height of the arm body 54A and the positioning portion 54B. In addition, the height of the lock portion 54C gradually decreases toward the mounting direction. Namely, the upper portion of the lock portion 54C is inclined with respect to the horizontal direction in a side view. The inclination angle of the upper portion of the lock portion 54C matches the inclination angle of the bottom surface of the latches 30. As shown in FIG. 7, the arm body 54A is inclined outward by a predetermined angle θ with respect to the front-rear direction in a plan view. The lock portion 54C is formed parallel to the front-rear direction. The positioning portion 54B protrudes inward more than the arm body 54A and the lock portion 54C in a plan view. The arm body 54A is configured to be elastically deformable in the left-right direction (+X direction, −X direction). When the arm body 54A elastically deforms in the left-right direction, the positioning portion 54B and the lock portion 54C formed on the tip side of the arm body 54A move in the left-right direction. In the present embodiment, since a dual-core optical connector plug is used, the latch 30 and lock arm 54 are provided for each of the two optical fibers 1, and the two lock arms 54 are arranged at positions sandwiching the two latches 30 in a plan view.

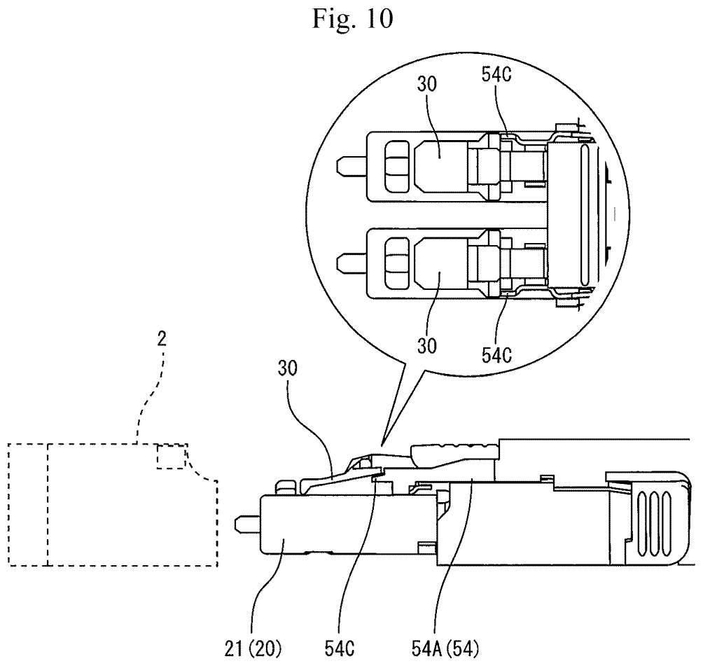

Hereinafter, the operation of each part when attaching and detaching the optical connector plug 10 to and from the optical adapter 2 will be explained, focusing on the operations of the latches 30 and lock arms 54. FIGS. 10 to 13 show side views of the optical adapter 2 and the optical connector plug 10 and enlarged plan views of the vicinity of the lock arms 54. In the above described figures, the optical adapter is shown with broken lines as a see-through view of the inside of the optical adapter 2. Note that the optical adapter 2 is omitted in the plan views. FIG. 10 is a view showing a state where the optical adapter 2 and the optical connector plug 10 are separated. In the state shown in FIG. 10, the latches 30 are not elastically deformed and the lock arms 54 are also not elastically deformed. When the plug frame 21 of the optical connector plug 10 is not fitted to the optical adapter 2, the lock portions 54C are arranged at a position not overlapping the bottom surface of the latches 30 in a plan view.

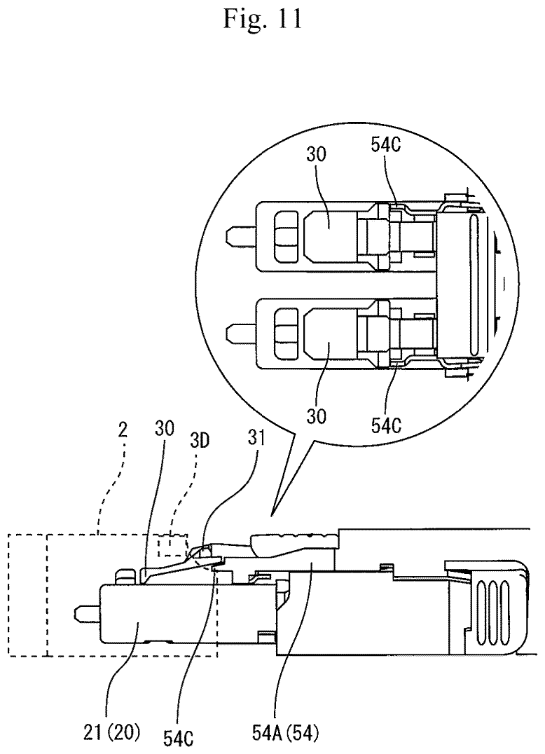

FIG. 11 is a view showing a state where the tip end of the optical connector plug 10 is inserted into the optical adapter 2. The tip end of the plug frame 21 is inserted into the plug accommodation hole 3A of the optical adapter 2, and the tip end of the latches 30 is inserted into the latch accommodation hole 3B of the optical adapter 2. The engaging portions 31 of the latches 30 and the lock portions 54C are inserted into the wide portion 3E of the optical adapter 2. The inclined portion at the tip end of the engaging portions 31 abuts against the protrusion 3D. Thus, a downward force is applied to the engaging portions 31 and the latches 30 begin to elastically deform downward. In the above described state, the lock arms 54 are not yet elastically deformed.

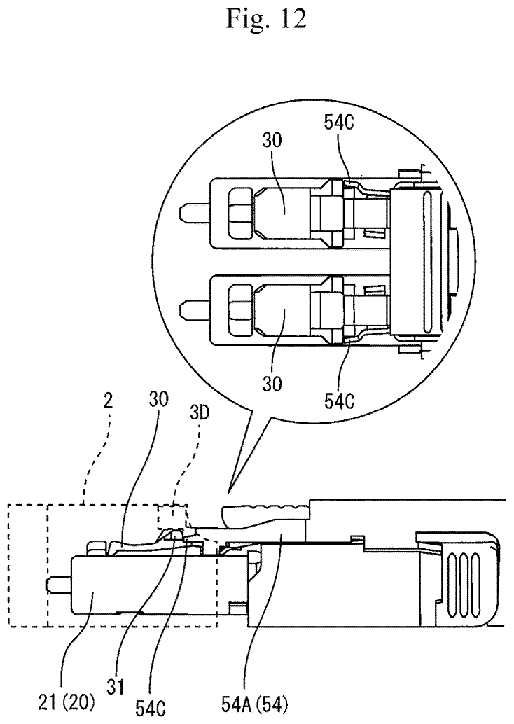

FIG. 12 is a view showing a state where the optical connector plug 10 is further inserted into the optical adapter 2. When the optical connector plug 10 is further inserted into the optical adapter 2 from the state shown in FIG. 11, the engaging portions 31 of the latches 30 enter below the protrusion 3D and the latches 30 further elastically deform downward. As described above, since the arm body 54A is inclined outward by a predetermined angle θ in a plan view, the arm body 54A of the lock arm 54 is pressed inward in the left-right direction by the protrusion 3C of the optical adapter 2 and elastically deforms. However, when the latches 30 are deformed downward, the lock portions 54C may abut against the side surface of the latches 30 and cannot move further inward. Namely, the lock portions 54C do not enter below the bottom surface of the latches 30.

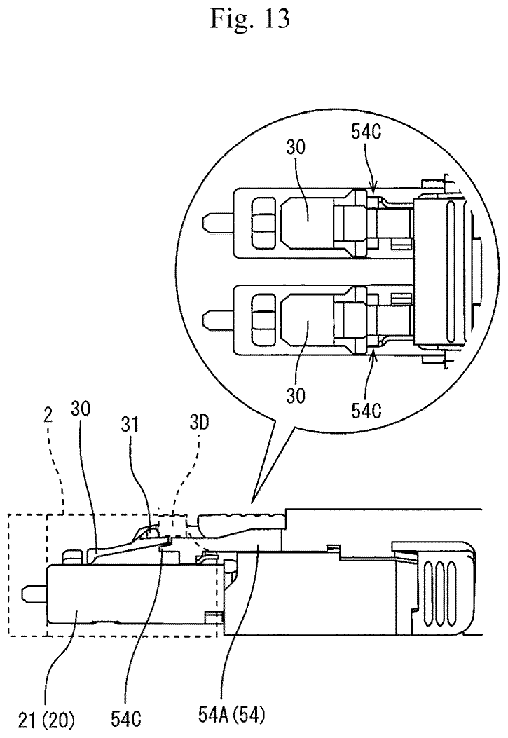

FIG. 13 is a view showing a state where the optical connector plug 10 is fitted to the optical adapter 2. When the optical connector plug 10 is further inserted into the optical adapter 2 from the state shown in FIG. 12, the engaging portions 31 of the latches 30 get over the protrusion 3D of the optical adapter 2. Since the upper surface of the engaging portions 31 no longer abuts against the protrusion 3D, the elastic deformation of the latches 30 is released and the tip end of the latches 30 moves upward. When the tip end of the latches 30 moves upward, the arm bodies 54A pressed inward by the protrusion 3C protruding inward from the side wall of the optical adapter 2 elastically deform inward in the left-right direction. Because of this, the lock portions 54C formed at the tip end of the lock arms 54 are moved inward in the left-right direction. When the lock portions 54C move inward, the lock portions 54C are arranged at a position overlapping the bottom surface of the latches 30 in a plan view. At this time, a slight gap is formed in the up-down direction between the bottom surface of the latches 30 and the upper surface of the lock portions 54C. However, since the lock portions 54C are arranged below the latches 30, downward movement of the latches 30 is restricted. As explained above, when the optical connector plug 10 is fitted to the optical adapter 2, the lock arms 54 are pressed by the inner wall of the optical adapter 2. Thus, the lock portions 54C move to a position overlapping the bottom surface of the latches 30 in a plan view. Namely, the lock portions 54C are positioned between the bottom surface of the latches 30 and the upper surface of the plug bodies 20. It can also be said that the lock portions 54C are arranged within the range of the movement region when the latches 30 move downward.

To remove the optical connector plug 10 from the optical adapter 2, the slider 40 is slid in the removal direction. Since the lock tool 50 is configured to move in conjunction with the slider 40, when the slider 40 is moved in the removal direction, the lock tool 50 also moves in the removal direction. When the lock tool 50 moves in the removal direction, the lock portions 54C formed at the tip end of the lock arms 54 move in the removal direction. When the end portion of the lock portions 54C in the mounting direction moves to a position not overlapping the bottom surface of the latches 30 in a plan view, the restriction of downward movement of the lock portions 54C by the latches 30 is released. As described above, when the slider 40 is slid in the removal direction, the latches 30 are pressed downward by the slider 40. When the restriction by the lock portions 54C is released, the latches 30 elastically deforms downward and the engaging portions 31 move below the lower surface of the protrusion 3D. When the optical connector plug 10 is pulled in the removal direction together with the slider 40, the optical connector plug 10 is removed from the optical adapter 2. Note that the jig 60 may be used when sliding the slider 40 in the removal direction.

As explained above, the optical connector plug 10 of the present application has the lock arms 54 configured to be movable relative to the latches 30, and the lock portions 54C formed at the tip end of the lock arms 54 are arranged at a position not overlapping the bottom surface of the latches 30 in a plan view when the optical connector plug 10 is not fitted to the optical adapter 2. When the optical connector plug 10 is fitted to the optical adapter 2, the lock arms 54 are pressed inward by the inner wall of the optical adapter 2. Thus, the lock portions 54C move to a position overlapping the bottom surface of the latches 30 in a plan view. When the lock portions 54C are arranged at a position overlapping the bottom surface of the latches 30 in a plan view, movement of the latches 30 toward the outer surface of the plug frame 21 of the plug body 20 is restricted. In the above described state, even if a force pressing the latches 30 or the slider 40 downward is applied, the latches 30 abut against the lock portions 54C. Thus, the latches 30 are prevented from moving downward beyond a certain distance (the width of the gap between the bottom surface of the latches 30 and the upper surface of the lock portions 54C). Therefore, the engaging portions 31 do not move below the lower surface of the protrusion 3D. Thus, the release of the fitting of the optical connector plug 10 to the optical adapter 2 can be prevented. The certain distance is the distance to a position where the connection between the optical connector 10 and the optical adapter 2 is not released when the bottom surface of the latches 30 and the upper surface of the lock portions 54C abut against each other.

When removing the optical connector plug 10 from the optical adapter 2, the lock arms 54 are moved in a direction away from the optical adapter 2 (−Y direction). Thus, the lock portions 54C move to a position not overlapping the bottom surface of the latches 30 in a plan view. Since the lock arms 54 are configured to slide in conjunction with the slider 40, the lock arms 54 can be moved by moving the slider 40 in a direction away from the optical adapter 2. Even if forces in the up-down direction or left-right direction are applied to the slider 40 or the lock arms 54, the fitting of the optical connector plug 10 to the optical adapter 2 is not released. However, when the slider 40 or the lock arms 54 are moved in the removal direction, the fitting of the optical connector plug 10 to the optical adapter 2 can be released.

Since the lock arm 54 has the positioning portion 54B, the left-right position of the latch 30 relative to the lock arm 54 can be restricted within a certain range. Because of this, the lock portion 54C is moved more reliably to a position overlapping the bottom surface of the latch 30 when the lock portion 54C of the lock arm 54 is moved by the inner wall of the optical adapter 2.

In the above described embodiment, a dual-core optical connector plug incorporating two optical fibers is explained as an example. However, the optical connector plug to which the present invention is applicable is not limited to the dual-core optical connector plug. By changing the number of plug frames, the present invention can be similarly applied to a single-core optical connector plug incorporating one optical fiber or a multi-core optical connector plug incorporating three or more optical fibers.

In the above described embodiment, a structure in which the lock arms are pressed horizontally by the protrusion portion provided on the side wall of the optical adapter when the optical connector plug is fitted to the optical adapter is explained as an example. However, it is not necessary to provide the protrusion on the side wall. In addition, a structure in which the lock arms are pressed by an inner wall other than the side wall of the optical adapter may be used. Alternatively, a protrusion for pressing the lock arms may be formed on an inner wall other than the side wall. Note that all of the above-described forms are included in the configuration in which the lock arms are pressed by the inner wall of the optical adapter.

In the above described embodiment, expressions such as the up-down direction and the bottom surface of the latch are used. These are directions when viewing the optical connector plug alone. Of course, when the optical connector plug is mounted to the optical adapter in a state rotated by 90°, the up-down direction of the latch faces the horizontal direction, and the bottom surface of the latch becomes parallel to the vertical direction.

In the above described embodiment, a structure in which the lock arms are pressed by the inner wall of the optical adapter and elastically deformed when the optical connector plug is fitted to the optical adapter so that the lock portions move to a position overlapping the bottom surface of the latches in a plan view is described as an example. However, the present invention is not limited to a structure in which the lock arms elastically deform. Any structure may be used as long as the position of the lock portion is changed relative to the latch when the lock arm is pressed by the inner wall of the optical adapter. For example, a structure that changes the position of the lock portion using mechanical structures such as a slider or a spring is also possible.

In the above described embodiment, a structure in which a slight gap is formed in the up-down direction between the bottom surface of the latch and the upper surface of the lock portion when the optical connector plug is fitted to the optical adapter is explained as an example. However, the bottom surface of the latch and the upper surface of the lock portion may be configured to abut against each other at this time. Any structure may be used as long as the lock portion is arranged at a position overlapping the bottom surface of the latch in a plan view when the optical connector plug is fitted to the optical adapter.

In the above described embodiment, the portion arranged at a position overlapping the bottom surface of the latch in a plan view when the optical connector plug is fitted to the optical adapter is called the lock portion. However, the lock portion does not necessarily need to be a portion clearly distinguished from other portions in the lock arm. It is enough if a part of the lock arm is movable between a position overlapping a part of the bottom surface of the latch and a position not overlapping the part of the bottom surface of the latch. Note that the bottom surface of the latch here refers to the bottom surface of the portion that moves in the up-down direction in the latch.

In the above described embodiment, a structure in which the arm body is pressed inward by the inner wall of the optical adapter by inclining the arm body outward by a predetermined angle θ is explained. However, the present invention is not limited to the above described structure. When the lock arm includes a portion protruding toward the inner wall side of the optical adapter from a straight line connecting the tip end of the lock portion and the base end portion of the lock arm in a plan view, an effect similar to inclining the arm body outward can be obtained.

In the above described embodiment, an example in which the lock arm is configured to slide in conjunction with the slider is described. However, the present invention is not limited to the above described structure. The lock arm may be configured to move in the front-rear direction independently of the slider. In addition, it is not necessary to configure the lock member as a component independent of the slider. For example, when the lock arm is formed integrally with the slider, it is possible to give the slider the function of the lock member.

Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

### DESCRIPTION OF THE REFERENCE NUMERALS

1: optical fiber cable, 2: optical adapter, 3: fitting hole, 10: optical connector plug, 20: plug body, 21: plug frame, 22: latch frame, 30: latch, 31: engaging portion, 40: slider, 41: cover portion, 42: grip portion, 43: insertion hole, 50: lock tool, 51: body portion, 52: leg portion, 53: wide portion, 54: lock arm, 54A: arm body, 54B: positioning portion, 54C: lock portion, 60: jig

1. An optical connector plug fitted to an optical adapter, the optical connector plug comprising:
a plug body that accommodates an optical fiber in the plug body;
a latch configured to be engageable with the optical adapter by moving a tip end of the latch in a vertical direction; and
a lock arm configured to be movable relative to the latch, wherein
the lock arm includes a lock portion configured to be movable between a first position overlapping a bottom surface of the latch and a second position not overlapping the bottom surface of the latch in a plan view,
when the optical connector plug is not fitted to the optical adapter, the lock portion is arranged at the second position not overlapping the bottom surface of the latch in the plan view, and
when the optical connector plug is fitted to the optical adapter, the lock arm is pressed by an inner wall of the optical adapter so that the lock portion moves to the first position overlapping the bottom surface of the latch in the plan view.

2. The optical connector plug according to claim 1, further comprising:
a slider configured to be slidable relative to the plug body, wherein
when the slider is slid, the latch is configured to move toward an outer surface of the plug body.

3. The optical connector plug according to claim 1, wherein
when the optical connector plug is fitted to the optical adapter, the lock portion is positioned between the bottom surface of the latch and an outer surface of the plug body to restrict a movement of the latch toward the outer surface of the plug body.

4. The optical connector plug according to claim 2, wherein
the lock arm is configured to slide in conjunction with the slider.

5. The optical connector plug according to claim 1, wherein
when the optical connector plug is removed from the optical adapter, the lock arm is configured to move in a direction away from the optical adapter so that the lock portion moves to the second position not overlapping the bottom surface of the latch in the plan view.

6. The optical connector plug according to claim 1, wherein
when the optical connector plug is fitted to the optical adapter, the lock arm is pressed by the inner wall of the optical adapter and elastically deformed so that the lock portion moves to the first position overlapping the bottom surface of the latch in the plan view.

7. The optical connector plug according to claim 1, wherein
the inner wall of the optical adapter is a side wall of the optical adapter, and
when the optical connector plug is fitted to the optical adapter, the lock arm is pressed horizontally by the side wall of the optical adapter so that the lock portion moves to the first position overlapping the bottom surface of the latch in the plan view.

8. The optical connector plug according to claim 1, wherein
the lock portion is formed on a tip end side of the lock arm, and
the lock arm includes a portion protruding toward the inner wall of the optical adapter from a straight line connecting a tip end of the lock portion and a base end of the lock arm in the plan view.

9. The optical connector plug according to claim 1, wherein
the lock arm has a positioning portion protruding upward on both sides in a width direction of the latch.

10. The optical connector plug according to claim 1, wherein
the optical connector plug is a dual-core plug accommodating two optical fibers, each of the two optical fibers corresponding to the optical fiber,
the latch and the lock arm are provided for each of the two of the optical fibers, and
two lock arms are arranged at positions sandwiching two latches in the plan view, each of the two lock arms corresponding to the lock arm, each of the two latches corresponding to the latch.

11. A lock tool mounted on an optical connector plug fitted to an optical adapter, wherein
the optical connector plug includes: a plug body that accommodates an optical fiber in the plug body; and a latch configured to be engageable with the optical adapter by moving a tip end of the latch in a vertical direction,
the lock tool includes a lock arm configured to be movable relative to the latch,
the lock arm includes a lock portion configured to be movable between a first position overlapping a bottom surface of the latch in a plan view and a second position not overlapping the bottom surface of the latch in the plan view,
when the optical connector plug is not fitted to the optical adapter, the lock portion is arranged at the second position not overlapping the bottom surface of the latch in the plan view, and
when the optical connector plug is fitted to the optical adapter, the lock arm is pressed by an inner wall of the optical adapter so that the lock portion moves to the first position overlapping the bottom surface of the latch in the plan view.
